(19) United States
(12) Patent Application Publication
(10) Pub. No.: US 2003/0222230 A1
(43) Pub. Date: Dec. 4, 2003

(54) Method and apparatus for the capture of scanning positions in printed images

(76) Inventors: Ralf Brauner, Leipzig (DE); Rene Becker, Profen (DE); Bernd Morgenstern, Leipzig (DE); Matthias Nikolai, Panitzsch (DE); Thomas Krause, Detmold (DE)

Correspondence Address: KNOBBE MARTENS OLSON & BEAR LLP, 2040 MAIN STREET, FOURTEENTH FLOOR, IRVINE, CA, 92614, US

(21) Appl. No.: 10/410,696

(22) Filed: Apr. 8, 2003

(30) Foreign Application Priority Data
Apr. 9, 2002 (DE) 102 15 548.8

(51) Int. Cl. G01V 8/00

(52) U.S. Cl. 250/559.29

(57) ABSTRACT

An apparatus for capturing scanning positions in printed images avoids waste. The apparatus has a substantially plane working face for at least one master copy or part of the master copy of the printed image. The apparatus includes further a measuring device coupled to the working face for generating coordinates of positions to be marked in the master copy in accordance with a relevant point of the working face corresponding to the marked position. Further, the apparatus includes a stop device for the defined alignment of the master copy relative to the measuring device, and a computer unit for processing the data of the obtained coordinates.

### BACKGROUND OF THE INVENTION

1. Field of the Invention

The present invention relates to a method and an apparatus for the capture of scanning positions in printed images.

2. Description of the Related Technology

In the printing industry it is very often necessary to monitor the printed substrate in its moving condition for which, among other devices, very often video cameras are used. The problem is to exactly define the interesting image section and to reproducibly scan it with suitable means on the moving product stream. Normally a digitizer is used which enables the synchronization with the travelling product stream to become reproducible. A lateral alignment perpendicularly to the product stream is achieved through a monitoring setup like, for example, a camera arrangement along an accordingly fixed crossbar. Coordinates can be assigned to the resulting variable movements through digitizer impulses, for instance, or scales, so that the image section to be monitored can be retrieved.

With known solutions to this problem, for example, the camera arrangement for tracing image sections, normally consisting of a video camera, is manually moved relatively to the product stream with a key pad remote control until the correct coordinate across the web travel direction has been found. The correct moment for image recording in web travel direction is put off also with a remote control device from recording to recording until the required image section appears on a monitor. Then the size of the image section is varied by adjusting the zoom lens until it meets the demands. With another known method the automatic adaptation of the zoom position to the requirements of the particular monitoring task is achieved through image evaluation.

Furthermore, solutions are known with which a reference is made to the printed sheet by printing an identification mark and optical scanning of this mark on the printed product with a suitable sensor, like e.g., a reflection-type measuring head. The purpose is to facilitate and speed up the retrieval of a position in circumferential or lateral direction, or both.

All these known methods have in common that images are consecutively printed on a moving web and have to be scanned. This has proven to be especially disadvantageous in such cases where only through the capture of, for instance, a video picture a quality parameter can be fed into an automatic control unit or a so-called presetting. Until the correct position has been found sheets may be printed that do not meet the quality requirements and therefore become waste. This again causes considerable financial losses.

### SUMMARY OF CERTAIN INVENTIVE ASPECTS

It would principally be conceivable that prior to the printing operation the coordinates of the described monitoring positions could be measured with the aid of a master image. Such a procedure would save paper, however, time and manpower requirement would be so high that the procedure is ruled out in practice.

A problem analogous to those discussed above arises if during the process of printing a locally measuring sensor system, like e.g. a camera, is to be moved from one position of the printed image to another. Normally the operator will see only a section of the printed image on the monitor. He will know how the position looks like at which the measurement is to be carried out, however, only a trial-and-error procedure, with which the operator checks his operations on the basis of the respective results, will help him to really approach the new monitoring position from the previous one. This causes considerable losses of time and, possibly, waste again.

Therefore, it is an object of certain inventive aspects to create a method and an apparatus for the capture of scanning positions on printing images, which offer a fast and reliable possibility to find a position on a printed copy.

Accordingly, one inventive aspect relates to a method for capturing scanning positions in printed images. A master copy of the printed image is generated and placed in a predetermined alignment on a grid of coordinates. At least one scanning position is manually marked and coordinates of the marked scanning position are automatically captured. The captured coordinates are stored.

Another inventive aspect relates to an apparatus for capturing scanning positions in printed images. The apparatus has a substantially plane working face for at least one master copy or part of the master copy of the printed image. The apparatus includes further a measuring device belonging to the working face for generating coordinates of positions to be marked in the master copy in accordance with a predetermined point of the working face corresponding to the marked position. Further, the apparatus includes a stop device for the defined alignment of the master copy relative to the measuring device, and a computer unit for processing the data of the obtained coordinates.

According to one embodiment, a master copy of the printed image is produced. The master copy can be a master sheet or a reference sheet, a printing plate, a film or the projection of a printed sample, which need not be true to size. Further, it is also possible for achieving the same effects to produce a copy of the printed sheet with electronic means.

If this master copy or the alternative copy of the print sample are superimposed in defined alignment on a coordinate grid, any position both on the master copy and the printed sheet assigned to it can be captured.

This position can, for example, be determined in such a way that a person puts his/her finger on a certain position of the master copy, the coordinates of which are then captured.

Alternatively it is of course also possible to mark the desired scanning position manually with appropriate means.

The method in accordance with one embodiment makes it possible to determine a position without moving the web to be monitored or another object intended for the definition of positions, so that—at least to a large extent—the problems related to the state-of-the-art can be eliminated.

Another advantage arises from the fact, that the operator has the complete object at his/her disposal for monitoring, so that all definitions of positions and inputs can always be made with reference to the complete printed image to be monitored. This is especially advantageous if several equal printing subjects are arranged on one and the same printed sheet and the captured image section does not show which of the subjects is being monitored at the moment.

Preferably the relationship between the printed sheet and a machine position necessary for image capturing is, for example, established in such a way that the center of the printed sheet or the master copy, and thus, the center of the web, is positioned on a marked center of the coordinate grid with the lead edge of the printed image always set on a pre-determinable position of the coordinate grid.

In one embodiment, the method can be employed for the dedicated movement of, e.g., a camera during the printing process as well as for the pre-definition of positions in the printed image without the necessity to run the press and print.

Thus, it is possible according to one embodiment invention to predetermine a printing job with regard to the image position chosen for the monitoring of said printing job before the press is made ready. This possibility saves time and material during the set-up of the printing press for a new job.

Further adaptations to different fields of application are possible due to the fact that special functions having, e.g., a relationship with the definition of an image section or the control of cameras or other sensory tasks but also functions with a local relation to the printed sheet have been taken into account.

Such a function could, e.g., be the setting of zoom lenses, the iris (aperture) or the focus but also the fine movement of the image position.

The apparatus in accordance with one embodiment could, for example, be designed as a table with a working face for taking the master copies and said working face provided with a sensible coordinate measuring area.

In an especially favored design this table can be subdivided into different function areas.

A mechanical stop can for instance serve to fix the master copy and to create the local coordination between the master copy and the coordinate measuring table. Here it is principally possible to lay the master copy reflecting the printed sheet on the table in such a way that, e.g., the left edge of the master copy rests against the stop. In this case it is possible that the lower edge of the master copy is exactly set against the lower edge of the active part of the table.

Furthermore it is possible to assign a scale on the table to an existing ink control system.

The table can furthermore have an area provided with operating fields. Each of these fields can preferably work like a push button and activate different functions. With respect to the control of a camera such functions could for instance be zoom, focus, iris, forward/rearward motion, left/right motion or similar functions. They could also serve to select operating modes. One such button can, for example, cause the following operation on the table or the coordinate grid to be interpreted as the center of the image position which shall be the target of the camera position. Another field can cause the following operation to be interpreted as the circling of an area which shall be the next area to be viewed.

Finally, fields can be provided with which the iris of the camera can be opened or closed.

Another field can be provided to deliver status signals about display elements installed in this field.

In another embodiment, the coordinate grid is surrounded with a frame below which, for example, a measuring system can be accommodated.

Furthermore it is possible to provide a processing unit, for example, in form of an intelligent computer configuration, which is in charge of the selection and evaluation of transmitter and receiver modules and preferably communicates with connected systems like, for example, the printing press.

On the basis of certain inventive embodiments, it is also possible to show the master copy of the printing sample on a display screen and to use suitable interactive means like, for example, a touch-screen device on the monitor for the input of positions in a way analogous to the procedures described above. The basis for the display of the printing sample on the monitor can be a digital copy of the printed sample.

### BRIEF DESCRIPTION OF THE DRAWINGS

Further details, characteristics and advantages of certain inventive features will be more apparent from the following description of certain inventive exemplary embodiments in conjunction with the following drawings, wherein:

FIG. 1 is a schematic illustration of one embodiment of an apparatus for capturing scanning positions in printed images; and

FIG. 2 is an illustration of a procedure representing a method for capturing scanning positions in printed images.

### DETAILED DESCRIPTION OF CERTAIN INVENTIVE EMBODIMENTS

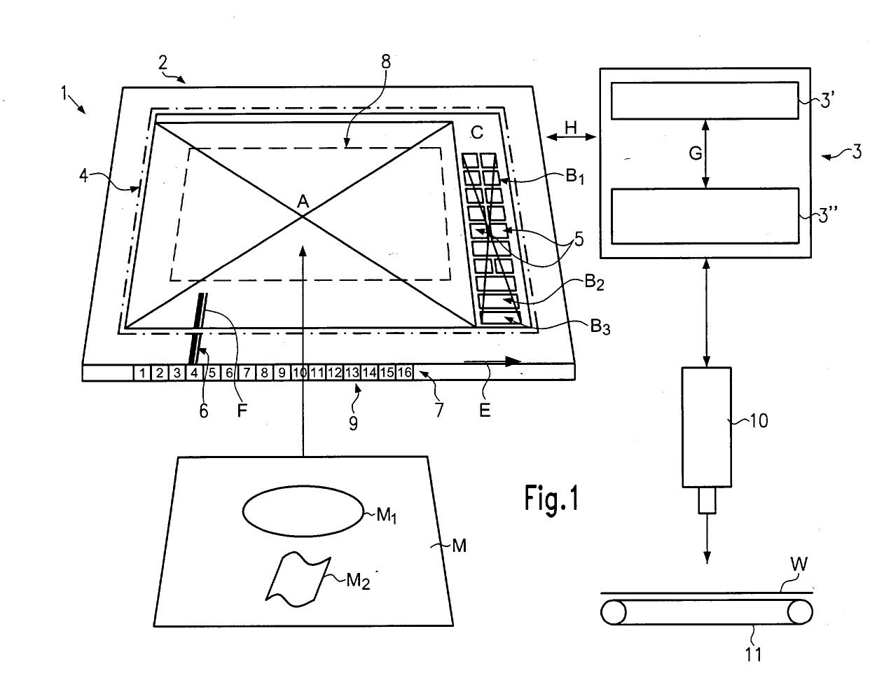

In FIG. 1, the depicted example of an apparatus 1 for the capture of scanning positions in printed images comprises a table 2 on which a coordinate measuring area is defined with a dash-dotted line 4. A working face A has been provided within said coordinate measuring area 4 on which a picture copy or a master copy M can be laid down. The master copy M is depicted in a schematically simplified way and comprises two image areas M1 and M2 in the case of the shown example.

Furthermore the apparatus 1 includes a control panel 5 which comprises a plurality of control keys, three of which have in FIG. 1 been marked with the reference numbers B1, B2, B3.

The version shown in FIG. 1 contains a display field C in the upper area of the control panel 5, which in this embodiment of the apparatus displays status information.

Furthermore, the apparatus 1 comprises a stop device 6, which, for example, can be a stop bar F movable in the direction of the arrow E (corresponding, for example, to the X-direction).

Furthermore, the table 2 includes a frame 7 surrounding the coordinate measuring area 4, below whose plane a measuring device 8 has been located indicated with a broken line in the depicted example.

Furthermore, the front surface of the frame 7 is preferably provided with a scale, which, for example, can belong to an ink control system, which serves the operator for ink feeding as reference to the ink zones.

In one embodiment, the apparatus 1 finally contains a computer unit 3 which is inter-active with the table 2 and for example contains a processing unit 3′ and a bi-directional interface 3″ which are inter-active with each other symbolized by a double arrow G. Preferably the computer unit 3 serves the determination and assignment of coordinates and, therefore, serves as a processing unit, which carries out the triggering and evaluation of, for instance, transmitter and receiver modules of the measuring device 8. These optional interrelations between table 2 and computer unit 3 are symbolized by the double arrow H.

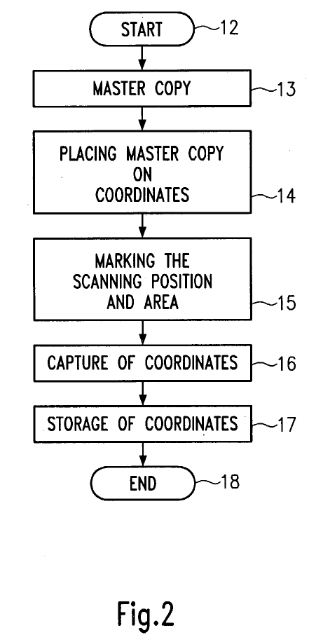

FIG. 2 is an illustration of a procedure representing a method for capturing scanning positions in printed images. The procedure starts at step 12 and performs initialization and housekeeping procedures. Referring to steps 13 and 14, if a master copy M is to be measured in accordance with one embodiment of the method, the copy M is put on the working face A which is a plane or at least almost plane surface. For a defined assignment to the coordinate measuring area 4 or the measuring device 8, in the case of this example the left edge of the master copy M can rest against the stop bar F and the lower edge of the copy against the lower edge of the active part of the table 2.

Referring to steps 15 and 17, the operator can then touch the image section M1 with his/her finger or, for example, with an aid like a pointer, which marks the scanning position and area and effects the automatic coordinate determination and capturing by the measuring device 8 and the further processing by the computer unit 3. As represented by step 17, this unit can, for example, buffer the determined coordinates and/or directly upload them to the printing press for the control of the camera. The procedure ends at step 18. The chronological control of the camera for the creation of a still image is still effected through synchronization with the speed of the travelling web.

In addition to the preceding description it must be mentioned that the coordinate measuring device 8 may be designed as a device which includes a grid of radiation-sender-receiver combinations which is arranged above the table and gains a locus information from the interruption of one or several radiation beams.

Furthermore the measuring device can be designed as a device consisting of a grid of transmitter-receiver combinations arranged on at least two sides above table 2 and which gains from the radiation emitted from the transmitting elements, reflected within the coordinate measuring area 4 and taken up by the receiving elements a locus information on the position of the object, especially of the M1 or M2 image sections of the master copy M.

Table 2 with the coordinate measuring device 8 can be designed as a touch-screen device with a monitor showing the printed image.

IR radiation or a supersonic energy radiation are conceivable as radiation emitted from the transmitters of the measuring device 8.

As an alternative the coordinate measuring device can be designed as an appliance which consists of a two-dimensional system installed in the surface of the table 2, which gains the information on the location of a contact or an exerted pressure through a method of resistance measurement (resistive method).

The computer unit 3 can be a personal computer, a micro-processor or a single-board computer.

The complete configuration may also comprise an interface unit which has not been depicted in the figure and which enables data exchange to be carried out with other electronic appliances also not shown in the figure.

The interface system may here be a CAN-bus interface or a RS485 interface.

The coordinate measuring area 4 may either cover the total area of the working face A of the figure or be only a sub-area of table 2 or the working area A respectively.

Furthermore, it is possible to design part of the coordinate measuring area 4 as a field whose coordinates are assigned to one or a plurality of other functions. Such functions can be operating functions with at least one of these operating functions activating, for example, a reference to the positioning of a sensor over the area of the master copy M and/or at least one of these operating functions initiating a positioning operation.

Again this positioning operation may have an effect on a camera 10 or a sensor system which on the printing press 11 is arranged over a travelling web W and there captures part of the web controlled by the apparatus, as illustrated in FIG. 1. The sensor system or the sensor may in this case be a video camera which preferably can automatically be moved in accordance with the gathered data.

Furthermore, it is possible for at least one of the operating functions to activate one or more operating modes. Here, one of these operating modes can be the interpretation of a series of captured coordinates as the measure of the size and the shape of an area. This interpretation may, for example, serve to determine the edge length of a rectangular area or the center of the area to be scanned. Furthermore, it is possible that this interpretation takes place as the determination of the diameter of a circle, or serves to determine the center of an area or the center of gravity of an area.

As a result of this interpretation the zoom lens of a camera can be adjusted.

Finally the above described functions can immediately be used as positioning and adjusting operations for the monitoring systems of the printing press.

Concerning the operating functions of a camera 10 for the monitoring of the web W which can be controlled with the apparatus 1, it has to be mentioned that at least one of these operating functions may effect the variation of the intensity of the camera 10 through the signals received by the sensors of the measuring device 8.

The operating functions may comprise the adjustment of the aperture of the video camera. It is also possible for at least one of the mentioned operating functions to effect the variation of the focus of a video camera, the variation of the zoom of a camera and/or the movement of the taken picture in the moving direction of the lens.

Furthermore, at least one of the mentioned operating functions can effect the vertical movement of the taken picture against the moving direction of the lens and another one of the mentioned operating functions can effect the selection of different illumination types or modes.

Furthermore, it is conceivable that another one of these operating functions effects the selection of the active camera in a multi-camera system and/or permits a selection of different working modes in the screen presentation.

Furthermore, at least one of the operating functions can permit the selection of specific evaluation modes which are applied to the taken picture and one of these evaluation modes can be the measurement of register marks, another one a colorimetric procedure, a further one a bar code check and, finally, a further one a comparison of image samples.

Finally, another operating function can activate or deactivate the measuring system and in doing this remain active itself.

Altogether it is possible that the described system is activated only after the execution of a predetermined operating sequence in a defined range of the coordinate capturing device and/or automatically becomes inactive again after a predetermined period of time has passed.

After the completion of an input the system can also become active again and/or become inactive again after the last completed input as soon as a predetermined period of time has passed by.

Finally, it is possible that even without being activated the system always internally determines and evaluates coordinates and therefrom preferably stores such coordinates which have been identified prior to the activation, shields these objects and considers them no longer and/or considers only these objects. In accordance with one embodiment of the method and one embodiment of the apparatus 1, it is furthermore possible to interpret the interruption of the beam path as the input of a coordinate only if the interrupting object is not bigger than a pre-defined size of maximally the diameter of a human being's finger and/or maximally the size of the object intended to operate the system. Preferably this size shall not be smaller than a pre-determined limit and in connection with an especially preferred version shall not be smaller than the diameter of an object intended for the operation of the system. The listed functions may also include calibration functions, which serve the calibration of the dimensions of the measuring field in relation to the object to which the coordinates shall be assigned, where at least one calibration function effects a lateral assignment of the object to table 2. As already mentioned the assignment can be effected through a stop like, for example, the stop bar F or centrally through a mark.

Furthermore, it is possible to achieve the lateral assignment through a printed mark, which with a separate scanning system is automatically searched for on the moving object and which via the interface unit transfers the detected position to the invented apparatus 1, which stores this position and assigns the same mark position as reference value to the object of the coordinate measuring device 8 positioned on the table 2.

It is also possible to determine the lateral assignment by scanning the travelling web with a camera and a connected image processing system. The system carries out an image analysis on the basis of which it determines the position of the object to be scanned, transmits the determined position via the interface unit to the invented apparatus 1 and, using the apparatus 1, assigns it to the coordinate grid 4 through the input of the same mark position on the object positioned on table 2.

The assignment of the object to table 2 in movement direction can also be provided as a calibration function. Here the assignment in movement direction is achieved through a mechanical stop for the positioning of the sample object. The assignment to the circumferential direction can be effected through the separate manual input of a reference position which for the determination of each coordinate will be taken into account by the computer 3.

The assignment in movement direction can be effected through a printed mark which on the moving object is automatically searched for with a separate scanning system. Via the interface unit the detected position is transmitted to the apparatus 1, which stores the position and assigns it as reference to the coordinate measuring system 8 through the input of the same mark position on the object positioned on table 2. In an alternative embodiment, it is possible to determine the assignment in circumferential direction by scanning the moving web with a camera and a connected image processing system. In this alternative embodiment, the system carries out an image analysis on the basis of which it determines the position of the object to be scanned, transmits the found position via the interface unit to the apparatus 1 and assigns it to the coordinate measuring system 8 through the input of the same mark position on the object positioned on table 2.

Furthermore, it is possible that at least one calibration function is provided which permits the scaling of table 2. The scaling can be effected in such a way that the object is laid down on the table, the calibration function is selected, the left lower corner and right upper corner are entered one after the other with the described appliance, the system compares the entered values with possibly already available format data, determines the position, and, if necessary, carries out the scale conversion of the object.

Furthermore, it is possible that at least one function is provided which automatically recognizes that an object with changed format is put on the table as master copy M and therefore automatically initiates a new scaling procedure. This format change can be derived from the evaluation of the permanently recorded coordinate signals on that part of the table 2, which takes the object or the master copy. This format change can also be effected by an additional image sensor with evaluation unit arranged above table 2. Alternatively it is also possible that additional sensors with a connected evaluation unit installed in table 2 recognize the format change.

According to one embodiment, it is also possible to integrate an ink control system with the coordinates of the coordinate measuring device or the coordinate measuring area 4 vertically assigned to the travel direction of the web and also to the coordinates “ink control” which permits the adjustment of an ink profile vertically to the travel direction. These operating functions may be ink control functions which are zonal control functions in an offset printing press and consist of at least one plus and one minus function which effect the increase or reduction of the zonal ink supply.

Furthermore, ink control elements can be provided which in their local assignment may have a sufficiently exact relation to the object placed on the table or to the master copy M and cause a change in that zone which has been assigned to the operating element. Further operating elements can be provided which may initiate other ink control functions without a local assignment. Finally, operating elements are conceivable which permit the selection of the required printing unit.

According to certain inventive aspects, it is also possible to include a touch screen for the pictured presentation of the object which is underlaid with the corresponding assignments and functions as they have been described above. It is conceivable that the object shown on the screen has been generated from the color separations of a so-called “preview image of the CIP3 file”. Furthermore, it is conceivable that the object shown on the screen was available as color image in another data format or that the image was generated from a packed file through randomizing.

Furthermore, it is conceivable that the image is presented as a selected partial image on a monitor with the assignment to the positions of the total image being calculated from the position within the partial image and the position of the partial image within the total image.

Superimposing the image a coordinate grid can be overlaid on the screen which likewise can be done with an ink zone screen. Finally, it is possible to operate the touch screen with a special stylus permitting a very accurate input of positions.

What is claimed is:

1. A method of capturing scanning positions in printed images, comprising:
generating a master copy of a printed image;
placing the master copy in a predetermined alignment on a grid of coordinates;
manually marking at least one scanning position;
automatically capturing coordinates of the marked scanning position; and
storing said coordinates.

2. The method according to claim 1, further comprising communicating the stored coordinates to a monitoring unit.

3. The method according to claim 2, further comprising manually marking an image section of the master copy by circling the at least one marked scanning position.

4. The method according to claim 2, further comprising activating a positioning of the monitoring unit during a printing process.

5. The method according to claim 2, further comprising positioning the monitoring unit prior to a printing process.

6. The method according to claim 1, further comprising placing the center of the master copy in the center of the coordinate grid.

7. The method according to claim 3, further comprising using the coordinates obtained through the circling of the marked scanning positions for a calculation and actuation of a zoom function of the monitoring unit.

8. The method according to claim 1, further comprising assigning evaluation functions to the image generated by the determined coordinates.

9. The method according to claim 8, wherein the evaluation functions include a bar code evaluation, a measurement of register marks, a color measurement, and a comparison of image samples.

10. The method according to claim 1, wherein data obtained prior to the capture of coordinates are interpreted as wrong data and separated.

11. The method according to claim 1, further comprising executing a calibration procedure through defining a zero position in the coordinate grid, wherein the coordinate grid for the master copy is brought into congruence with the coordinate grid for the printing press.

12. The method according to claim 1, further comprising performing a calibration operation including placing the master copy on the coordinate grid, entering coordinate values of a left side lower corner and a right side upper corner of the master copy, comparing the entered values with format data and a corresponding assignment of a position and, as a function of said comparing, converting a scale of the master copy being affected.

13. The method according to claim 1, wherein the master copy is one of the following: a master sheet, a reference sheet, a printing plate, a film, a projection of the printed image, an electronic copy of the printed image, and at least part of the aforementioned master copies.

14. An apparatus for capturing scanning positions in printed images, comprising:
a substantially plane working face for at least one master copy or part of the master copy of the printed image;
a measuring device coupled to the working face for generating coordinates of positions to be marked in the master copy in accordance with a predetermined point of the working face corresponding to said marked position;
a stop device for a predetermined alignment of the master copy relative to the measuring device; and
a computer unit for processing the data of the obtained coordinates.

15. The apparatus according to claim 14, wherein the working face is part of a table and the table is provided with a coordinate measuring area.

16. The apparatus according to claim 15, wherein the table is provided with a frame surrounding the coordinate measuring area with the measuring device located below a plane of said frame.

17. The apparatus according to claim 15, wherein the table comprises at least one of an operating panel and a display field.

18. The apparatus according to claim 17, wherein the operating panel is configured as a touch-screen device.

19. The apparatus according to claim 14, wherein the measuring device is located in a plane of the working face or above the plane of the working face.

20. The apparatus according to claim 14, wherein the stop device is configured as a movable stop bar.

21. The apparatus according to claim 14, further comprising a scale for ink control information.

22. The apparatus according to claim 14, wherein the computer unit comprises a personal computer, a micro processor or a single-board computer.

23. The apparatus according to claim 14, wherein the computer unit is interactively connected with a monitoring device of the printing press producing the printed image.

24. The apparatus according to claim 23, wherein the monitoring device comprises a video camera.
